(19) United States
(12) Patent Application Publication
(10) Pub. No.: US 2006/0090582 A1
(43) Pub. Date: May 4, 2006

(54) Ball screw

(75) Inventors: Juergen Osterlaenger, Emskirchen (DE); Ralf Mayer, Herzogenaurach (DE); Horst Muenck, Herzogenaurach (DE)

Correspondence Address: HEDMAN & COSTIGAN P.C., 1185 AVENUE OF THE AMERICAS, NEW YORK, NY, 10036, US

(73) Assignee: INA-SCHAEFFLER KG

(21) Appl. No.: 11/263,409

(22) Filed: Oct. 31, 2005

(30) Foreign Application Priority Data
Nov. 4, 2004 (DE) 10 2004 053 204.4

(51) Int. Cl. F16H 1/24

(52) U.S. Cl. 74/424.88

(57) ABSTRACT

Ball screw, having a spindle nut (1), on the inner circumference of which a helically wound ball groove (2) is formed, a return tube (4) being provided for balls (3), in which the balls are returned from an end to a beginning of the ball groove (2), lubricant channels (6, 9) provided with lubricant being formed on the inner circumference of the return tube (4), the injection moulded plastic return tube (4, 8) being longitudinally divided along a parting plane (E) into two half-tubes, the lubricant channels (6, 9) being arranged on both sides of the parting plane (E).

The present invention relates to a ball screw. Ball screws are capable of translating rotational movements into linear movements.

JP 63001852 A, for example, has disclosed a ball screw, the spindle nut of which has a helically wound ball groove on the inner circumference, a return tube being provided for the balls, in which balls are returned from an end to a beginning of the ball groove. Lubricant channels provided with lubricant are formed on the inner circumference of the return tube.

The object of the present invention is to specify a ball screw according to the features of the pre-characterizing part of Claim 1, the return tube of which, provided with the lubricant channels, can be easily manufactured. According to the invention this object is achieved in that the injection moulded plastic return tube is divided lengthways along a parting plane into two half-tubes, the lubricant channels being arranged on both sides of the parting plane. A simple injection moulding tool can be used in the case of the ball screw according to the invention. The half-tubes themselves and the lubricant channels can be produced in one single operation.

The parting plane preferably runs in the longitudinal mid-plane of the return tube. Both halves of the return tube can be produced in one and the same injection moulding tool and then combined to form the return tube. It is also possible to provide an injection moulding tube by means of which both half-tubes can be produced in one single operation, it being additionally possible to join the two half-tubes together by means of a film joint integrally formed onto both half-tubes.

For securely fixing the position of the two half-tubes in relation to one another, both of the half-tubes may be peg-jointed to one another. In this case it may be appropriate for the parting plane to be arranged at an interval from the lubricant channels. The contact surfaces of the two half-tubes are not reduced due to recesses on the outer shell of the tube. Pegs may be provided on these contact surfaces, together with opposing holes for engagement of the pegs.

The lubricant channels are suitably arranged in the transverse direction to the parting plane of the return tube. Removal from the mould following the injection moulding process is then possible with any problem.

The invention will now be explained in more detail below with reference to two exemplary embodiments depicted in a total of four figures, of which

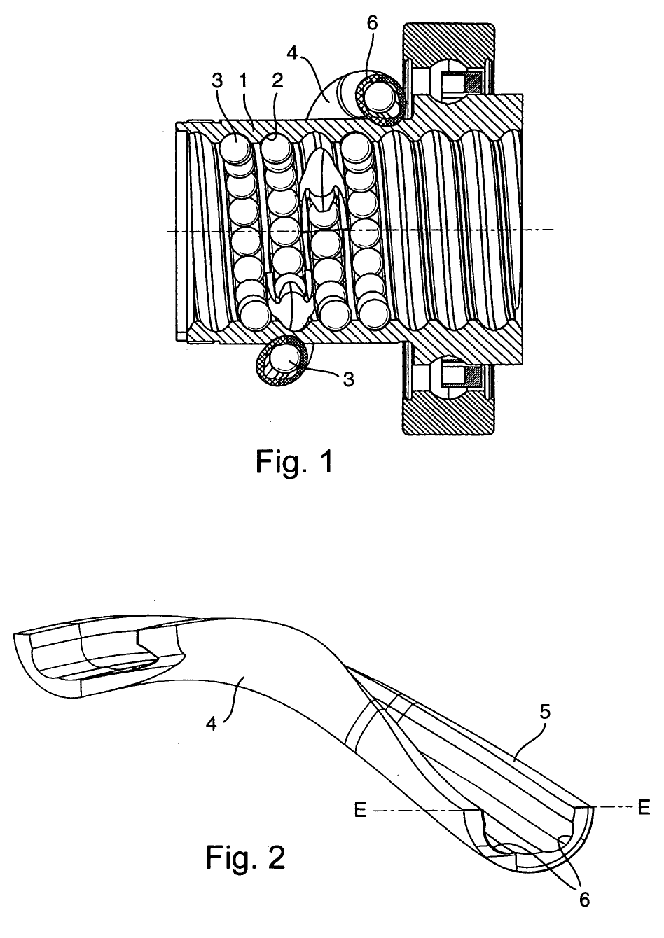

FIG. 1 shows a longitudinal section through a ball screw according to the invention,

FIG. 2 shows a half-tube of a return tube of the ball screw according to the invention in FIG. 1,

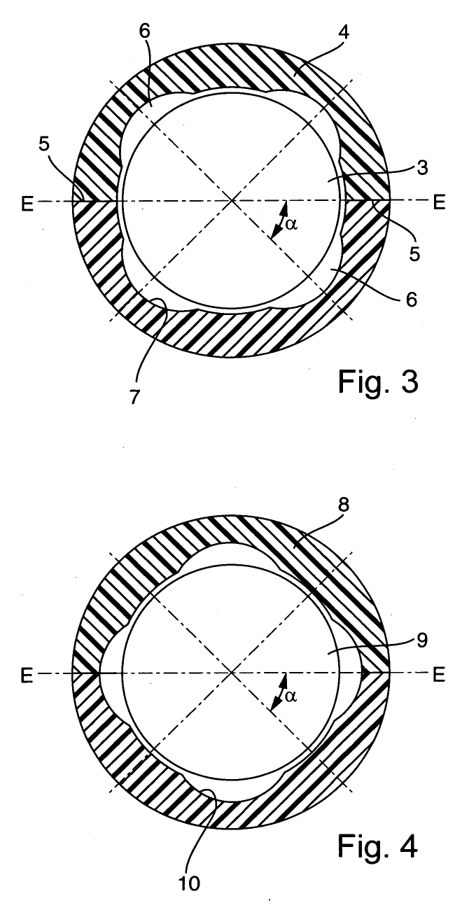

FIG. 3 shows a cross-section through the return tube of the ball screw according to the invention in FIG. 1 and

FIG. 4 shows a variant of a return tube according to the invention, represented in the same way as in FIG. 3.

### DETAILED DESCRIPTION OF THE DRAWING

The ball screw according to the invention depicted in FIG. 1 has a spindle nut 1, on the inner circumference of which a helically wound ball groove 2 is formed. This spindle nut 1 is rotatably arranged on a recirculating ball screw, not represented here. This recirculating ball screw is provided with a helically arranged ball groove. Balls 3 roll on the ball groove 2 of the spindle nut 1 and on the ball groove of the recirculating ball screw not represented here. For an endless circulation of the balls 3 a return tube 4 is arranged on the outer circumference of the spindle nut 1. The two ends of the return tube 4 are connected to the two ends of the ball groove 2. In this way an endless circulation of the balls is ensured.

FIG. 2 shows an enlarged representation of a half-tube of the return tube 4. The second half-tube is not shown here. The two half-tubes together form the return tube 4. The parting plane E here coincides with the longitudinal mid-plane of the return tube 4. At the parting plane E the wall of the return tube 4 forms a contact surface 5 for the half-tube arranged opposite. On these contact surfaces the two half-tubes may be provided with pegs alternating with holes for engagement of the pegs.

Lubricant channels 6 are formed on the inner circumference of the return tube 4 over the extent of the half-tubes. These lubricant channels 6 are arranged parallel to the parting plane E.

FIG. 3 shows a cross-section through the return tube 4 with a ball 3 arranged therein. The two half-tubes bear on one another with their contact surfaces 5. The lubricant channels 6 are provided with an arched wall 7.

The longitudinal centre lines of the lubricant channels 6 are arranged at an angle α in relation to the parting plane E. This angle α is preferably 45°. In this way, if the parting plane E is arranged in the longitudinal mid-plane of the return tube, two lubricant channels 6, which are arranged at an angle of approximately 90° to one another, are obtained on both half-tubes. This angular interval is calculated from 180° minus twice the value of the angle α=45°.

Lubricant (not represented here) is embedded in these lubricant channels 6. This lubricant may be a grease, but solid lubricants may also be used.

FIG. 4, in a cross-section like that in FIG. 3, shows a modified return tube 7, which is likewise formed from two half-tubes. In this case also, the parting plane E coincides with the longitudinal mid-plane of the return tube 7. In contrast to the return tube described above, the parting plane E here coincides with the centre lines of two lubricant channels 8 arranged diametrically opposite one another. One half of the lubricant channel 8 adjoining the parting plane E is formed on the one half-tube and the other half of the lubricant channel is formed on the other half-tube. This arrangement of the parting plane represents a simple way of ensuring that the lubricant channels are arranged without any undercut. In other words this means that in a transverse direction to the parting plane E the wall of the lubricant channels 9 is fully visible. On completion of the injection moulding process the tool can be opened without the need for special measures in order to run the injection moulding tool out of the lubricant channels 9.

Even if the parting plane E is arranged at a distance from the lubricant channels, as represented in the exemplary embodiment according to FIG. 3, for example, it is possible to form the lubricant channels without any undercut.

### LIST OF REFERENCE NUMERALS

1. Spindle nut
2. Ball groove
3. Ball
4. Return tube
5. Contact surface
6. Lubricant channel
7. Wall
8. Return tube
9. Lubricant channel
10. Wall

1. Ball screw, having a spindle nut (1), on the inner circumference of which a helically wound ball groove (2) is formed, a return tube (4) being provided for balls (3), in which the balls are returned from an end to a beginning of the ball groove (2), lubricant channels (6, 9) provided with lubricant being formed on the inner circumference of the return tube (4), characterized in that the injection moulded plastic return tube (4, 8) is longitudinally divided along a parting plane (E) into two half-tubes, the lubricant channels (6, 9) being arranged on both sides of the parting plane (E).

2. Ball screw according to claim 1, characterized in that the parting plane (E) is arranged in the longitudinal mid-plane of the return tube (4, 8).

3. Ball screw according to claim 1, characterized in that the parting plane (E) is arranged at an interval from the lubricant channels (6).

4. Ball screw according to claim 1, characterized in that the lubricant channels (9) are arranged without any undercut in the transverse direction to the parting plane (E).
